(19) United States
(12) Patent Application Publication
(10) Pub. No.: US 2010/0023345 A1
(43) Pub. Date: Jan. 28, 2010

(54) DETERMINATION OF A CONFIDENCE MEASURE FOR COMPARISON OF MEDICAL IMAGE DATA

(76) Inventor: David Schottlander, Sutton Courtenay (GB)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/507,141

(22) Filed: Jul. 22, 2009

(30) Foreign Application Priority Data
Jul. 22, 2008 (GB) 0813372.0
Jul. 20, 2009 (GB) 0912536.0

(51) Int. Cl. G06Q 50/00

(52) U.S. Cl. 705/2

(57) ABSTRACT

In a method and apparatus for calculation of a confidence measure indicating the validity of comparing medical scans such as PET or SPECT, the conditions for each scan are analyzed, with regard to conditions for various factors affecting Standardized Uptake Value (SUV). A scoring system assigns a score dependent on whether conditions are the same or different for each factor and the confidence measure is calculated from a combination of the scores, and a representation of the confidence measure is displayed.

### BACKGROUND OF THE INVENTION

1. Field of the Invention

The present invention is concerned with the processing of data representing medical imaging scans such as Positron Emission Tomography (PET) or Single Photon Emission Computed Tomography (SPECT) scans, and particularly with deriving an indication of the confidence with which such scans may be compared.

2. Description of the Prior Art

Increasingly, clinicians require capability aimed at comparing PET data for the same patient over time. A typical application of this technology in clinical use is the assessment of tumor response to treatment. The expectation is that using PET imaging, non-responders can be identified at an early stage and treatment can be changed. An approach that is routinely taken is to use standardized uptake values (SUV) as a basis for comparison, since SUV is easy to compute, and, in principle at least, provides an absolute number. Details of the calculation of SUV are provided below.

A problem is that in practice, there are many factors that affect the comparison of the absolute value of SUVs and all other measures of tracer activity, in intra-patient studies (within same patient). SUV values from two studies of the same patient can only be directly compared, if the method of measurement used in both studies is the same. For example, if the same reconstruction protocol was used, and if the same blood glucose levels exist. In practice this is almost never the case, a problem that is compounded when comparing longitudinal time-points of a patient that may have been acquired over the period of months or years, during which time imaging equipment in the hospital may have changed, or the patient may have moved to a different hospital.

As an example, for 2-[18F] fluoro-2-deoxy-D-glucose PET (FDG-PET) the factors that affect the absolute value of the SUV are summarized here, aside from disease state, can be divided into three sources:

1. those related to physiological differences,

2. those related to data acquisition and processing,

3. operator variability during data analysis and interpretation.

Physiological factors: There are many factors which influence the measured glucose uptake which do not relate to image acquisition and processing. These include:

Duration of fasting before FDG injection

Contents of last meal before fasting

Changes of body weight

Insulin level

Metabolic status (e. g. Diabetes mellitus or pre-diabetes)

Time between injection and scan

Hydration

Kidney function (FDG is excreted via kidneys)

Drug effects (e. g. cortisone)

Glucose level at injection time.

Some of these parameters can be controlled (e.g. keeping time constant between injection and scan), others can not be influenced (e. g. change of body mass and/or metabolic state).

Acquisition and processing factors: Factors related to acquisition and processing include:

Theoretical resolution of the scanner

Reconstruction algorithm (cutoff in FBP, number of iterations and subsets in iterative reconstruction)

Post reconstruction filtering

Patient motion

Calibration issues

In experienced centers, intra-patient studies are carried out with careful attention to patient preparation and use of ‘same’ protocols wherever possible. Large confidence margins are ensured in assessing how much change is clinically significant. Change of circa 30% is common, with smaller changes not being called as clinically significant. This is clearly less than satisfactory when attempting to assess response of a patient to treatment as early as possible.

For inexperienced centers, clinicians may use SUV values as absolutely accurate, without consideration of the imaging protocols, leading to misleading or erroneous diagnosis, which in turn could have serious negative effects on standard of patient care.

There exists a need for a system and method of determining a measure of confidence with which scans such as PET scans may validly be compared.

### SUMMARY OF THE INVENTION

In a method and apparatus in accordance with the present invention, for calculation of a confidence measure indicating the validity of comparing medical scans such as PET or SPECT, the conditions for each scan are analyzed, with regard to conditions for various factors affecting Standardized Uptake Value (SUV). A scoring system assigns a score dependent on whether conditions are the same or different for each factor and the confidence measure is calculated from a combination of the scores, and a representation of the confidence measure is displayed.

Preferably, the confidence measure is calculated as a weighted sum of scores, wherein each score has a value dependent on whether conditions or parameter values for a factor affecting SUV is the same or different in each scan.

The scan may be a PET scan or a SPECT scan.

Factors affecting the SUV for a PET or SPECT scan are considered and the associated conditions for each scan being compared are compared. A confidence measure is calculated which, in essence, represents a measure of how similar or different the conditions associated with factors affecting SUV are.

For example, as previously noted, the duration of patient fasting before injection is one factor which affects SUV. Hence, for each scan being compared the actual conditions for this factor (i.e. how long did the patient fast) are compared and where these conditions differ for each scan, the comparison has a detrimental effect on the confidence measure. In this case the difference in conditions is quantifiable, and the magnitude of the difference could be incorporated in the calculation of confidence measure. For other factors (e.g. reconstruction algorithm used) the comparison may only give rise to a Yes (the conditions are the same) or No (the conditions are not the same) answer and the effect on the calculation would be dependent on a knowledge of how much the choice of algorithm affects SUV.

### BRIEF DESCRIPTION OF THE DRAWINGS

FIG. 1 illustrates the basic method steps of the invention.

FIG. 2 provides an example of how information determined according to the invention may be presented to a user.

FIG. 3 illustrates apparatus suitable for performing the method of the invention.

### DESCRIPTION OF THE PREFERRED EMBODIMENTS

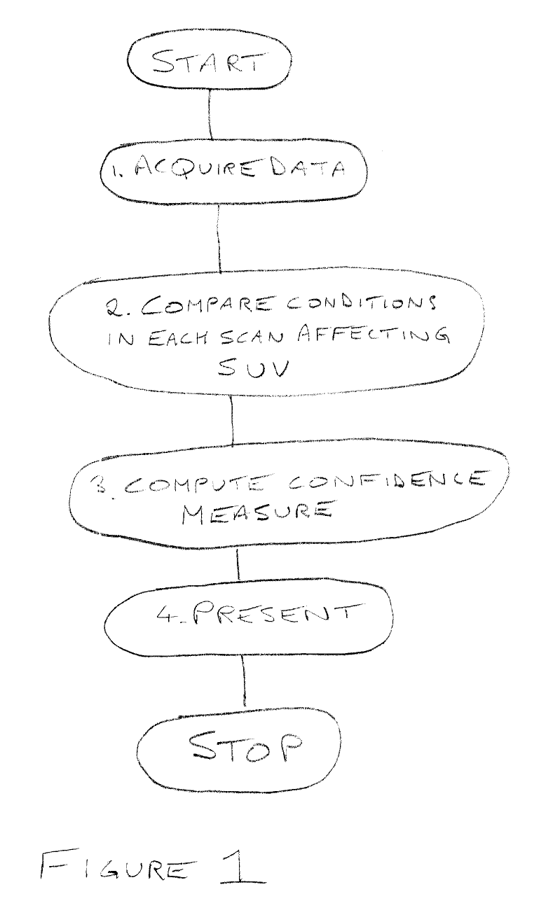

Referring to FIG. 1, the method of the invention begins at step 1 with the acquisition of at least two datasets representative of PET or SPECT scans. The data may be received from the scanning equipment or from data storage facilities.

At step 2, a comparison is made for factors affecting SUVs for each scan, that is, for a number of factors affecting SUV, the associated conditions for each scan are compared. From this comparison, a confidence measure is calculated, at step 3, which measure is dependent on the differences between conditions for each scan. Thus a confidence measure is derived which provides an indication of the validity of comparing the scans.

The confidence measure summarizes the significance of differences between a pair of studies. These measures represent the amount of trust that can be placed in absolute differences in SUV or other activity values between two studies.

Factors that influence the ability to compare two studies can be categorized into Protocol Specific Factors such as scanner, reconstruction algorithm and scan time, and Patient Specific Factors such as blood glucose level, weight change and fasting level. Appendix B contains a non-exhaustive list of factors.

By way of example, an aggregate confidence measure can be inferred from the data using a weighted sum of the differences in values for various parameters affecting SUV between the two studies, thereby penalizing differences between the studies. For example, table 1 illustrates calculation of a confidence measure for comparison of two scans where Reconstruction algorithm; number of iterations of the reconstruction algorithm (if applicable); detector material and whether the patient fasted prior to the scan were regarded as factors influencing SUV.

TABLE 1

| | | Condition at | Condition at | |
|---|---|---|---|---|
| Factor | Weight | Time point 1 | Time point 2 | Penalty |
| Reconstruction | 1 | OSEM | OSEM | 0 |
| algorithm | | | | |
| Iterations | 1 | 3 | 6 | 1 |
| Detector material | 1 | BGO | LSO | 1 |
| Patient fasted | 1 | Yes | No | 1 |
| NORMALIZED | | | | 3/4 = 0.75 |
| PENALTY | | | | |

In this example, uniform weighting was used; any factor for which the conditions were different between two studies is penalized by unit value. The total score in this example is that conditions were different for 3 factors out of 4 leading to a penalty of 0.75.

At step 4, the confidence measure is presented to a user.

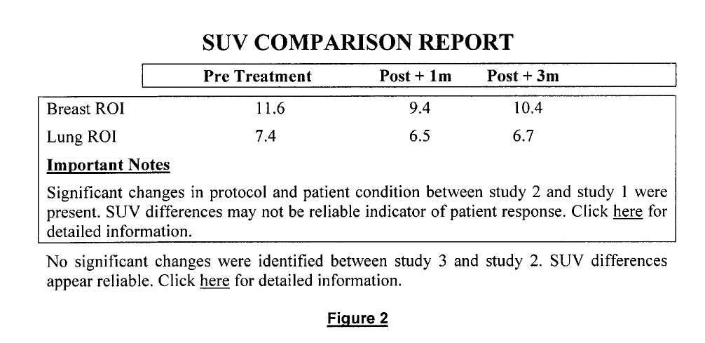

The example given in FIG. 2 illustrates the results of the system in determining the feasibility of comparing 3 datasets where the first dataset is denominated “Pre Treatment”, the second dataset was acquired 1 month post-treatment “Post+1 m” and the third dataset was acquired 3 months post-treatment “Post+3m”. Two regions of interest have been delineated as indicative of tumor condition in the images, one in the breast and one in the lung. The user typically inspects the value of PET uptake from the region of interest region of interest value at each time point and assesses whether it is increasing or decreasing. In FDG imaging, increasing values typically indicate worsening condition of the patient and reducing values indicate improving condition. This would however give a false indication if the imaging protocols were different between studies. In this example, after calculation of the confidence value according to the method (for example, described in section 4.2) the system identified that there is be poor confidence in the ability to compare studies 1 and 2 (so the physician can now know that the decrease in value for example in the breast ROI does not necessarily indicate response to treatment) and that the comparison of numbers should not be relied upon as an indicator of patient response. However, the confidence value is good between study 2 and 3 and therefore, the physician may safely interpret the minimal change between these two studies in the ROI values as indicative of non-response.

In this example, three levels of confidence are shown in the summary. Color coding may be used to present the information:

Red: significant differences were found in either protocols or patient condition

Amber: some low significance differences were identified in protocols or patient condition

Green: no significant differences were identified in protocols or patient condition.

Practically, not all the criteria about whether data-sets can be compared will be known, for example, measured glucose levels in the patient. Missing information will always be penalized with the result that if important information is missing, the comparison is unlikely to achieve a better score than amber.

In another embodiment, the weights of non-uniform weighting could be learned using a disease specific database of cases, for example a set of lung cancer cases, or a set of lymphoma cases. The training data-set would comprise the image data, a variety of all the parameters described above, and clinical assessment of ground truth representing whether the difference between any two datasets is significant or not. This ground truth could be obtained from patient outcome data or from expert assessment.

Another form of the same idea is for expert clinicians to determine the weight factors based on experience of long-term patient outcome studies.

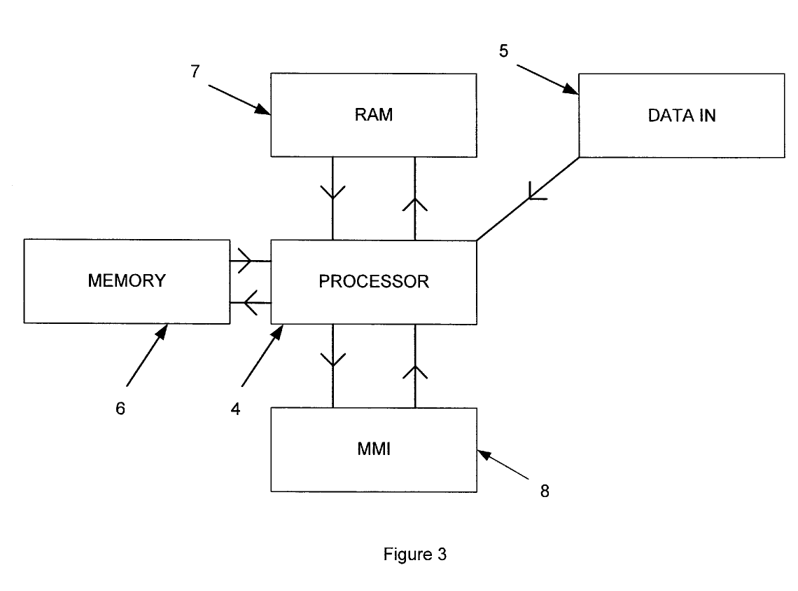

Referring to FIG. 3, the invention may be conveniently realized as a computer system suitably programmed with instructions for carrying out the steps of the method according to the invention.

For example, a central processing unit 1 is able to receive data representative of medical scans via a port 2 which could be a reader for portable data storage media (e.g. CD-ROM); a direct link with apparatus such as a medical scanner (not shown) or a connection to a network.

Software applications loaded on memory 3 are executed to process the image data in random access memory 4.

A Man—Machine interface 5 typically includes a keyboard/mouse/screen combination (which allows user input such as initiation of applications and a screen on which the results of executing the applications are displayed.

### SUV Calculation

Standardized uptake values (SUVS) have been reported to be a useful measure of tumor malignancy in PET oncology studies. SUVs have a broad appeal for clinical use as they provide an absolute number which is easily to compute in comparison with methods such as compartment modeling. Typically, values of >8 almost certainly represent malignant uptake whilst values of <2.5 are not high enough to allow a clinical diagnostic decision and may provide basis for further investigation.

The SUV calculation can be derived from the FDG state equations and is summarized as follows:

$$S U V = \frac{measured tissue concentration}{injected dose / normalizer}$$

In the original derivation, the normalizer is body weight. This comes from relating the concentration of FDG in the plasma to the injected dose divided by body weight of the subject. Subsequent reports have shown this to be a poor estimate due to the different distribution of tracer in fat and non-fat tissue, and have proposed other measures including dividing by body surface area or lean body mass.

$$normalizer = \{ \begin{matrix}B W \text{:} body weight \\ B S A \text{:} body surface area \\ L B M \text{:} lean body mass\end{matrix} \}$$

We note that the SUV formulation relies upon the assumption that the Lumped Constant (LC), that accounts for the differences in the transport and phosphorylation between [(18)F]FDG and glucose, is constant across different anatomical regions in the same patient, and between patients in the population.

Tables 2-5 summarize a set of factors that have an impact on the ability to compare SUV values between studies in a single subject. The Significance column expresses how significant the factor is in relation to this comparison and can be used to define the weighting factors using in calculating a penalty score.

TABLE 2
Acquisition Protocol Factors

| | | Value | |
|---|---|---|---|
| Factor | Notes | Range | Significance |
| Decay correction | | Binary | High |
| applied | | | |
| Attenuation | A/C may be | Binary | High |
| correction | effected by | | |
| | motion etc | | |
| Time of scan after | | Continuous | Depends on site of |
| injection | | scale | concern. Effect varies |
| | | | from minutes to hours. |
| Reconstruction | FBP. OSEM | List and | Medium, depends on |
| algorithm and | Filter, Filter | scale (for | algorithm |
| parameters | width | parameters) | |
| Scatter correction | | Binary | High |
| applied | | | |
| Randoms correction | | Binary | High |
| applied | | | |

TABLE 3
Analysis Protocol Factors

| | | Value | |
|---|---|---|---|
| Factor | Notes | Range | Significance |
| Recovery co-efficient/ | An assessment of whether | .Continuous | Depends on extent of |
| Partial Volume effect | R/C and PVE affect the | | partial volume. |
| | estimated activity IN the | | |
| | specified ROI (see footnote | | |
| | below). | | |
| | Calculated with a shape | | |
| | descriptor for the ROI | | |
| | (simplistically: elongated or | | |
| | spherical), compared with a | | |
| | tabulated list of known | | |
| | scanner resolutions | | |
| ROI method of | Whether the same ROI was | List | ? |
| placement | used as last time, or | | |
| | whether a new ROI was | | |
| | drawn. | | |
| ROI value used | | Mean, Max, | High |
| | | Other | |
| Type of SUV used | Normalization used | BW, LBM, | High |
| | | BSA | |
| Glucose level used in | Whether the glucose level | Binary | High |
| SUV calculation | was used or not. | | |

Note:
If using peak SUV(max), PVE will be due to the size of the region which is >90% max: if that region is very small (1 or 2 pixels), it is likely to be a value corrupted by reconstruction artifacts and therefore, is probably overestimated. If using mean SUV, PVE depends on the size and shape of the ROI.

TABLE 4
Measured Patient Factors

| | | Value | |
|---|---|---|---|
| Factor | Notes | Range | Significance |
| Fast status | Fasted or non-fasted prior | Binary | High |
| | to scan. This influences | | |
| | blood glucose level and | | |
| | can be used as an | | |
| | indicator if blood glucose | | |
| | level has not been | | |
| | measured. | | |
| Measured blood | This is related to fast | Continuous | High |
| glucose level | status; if we have this, fast | | |
| | status is not needed. This | | |
| | affects the rate of glucose | | |
| | uptake. | | |
| Pre/Post therapy | Whether the patient is pre- | Binary or | High, to be assessed |
| | or post- therapy. Patient | continuous | |
| | physiology may change | | |
| | significantly due to | | |
| | chemotherapy. Further | | |
| | analysis of typical change | | |
| | and whether this can be | | |
| | related to time after start | | |
| | of chemotherapy to be | | |
| | carried out before deciding | | |
| | how to represent the factor | | |
| | (binary or continuous | | |
| | representation). | | |
| Length of time after RT | Brown fat uptake in case | Continuous | Medium-High |
| | of stress is a classic cause | or banded | |
| | of false positive, as well as | | |
| | infection or RT healing | | |
| Anatomical location of | The location of the tumor | List of | Low |
| tumor | affects the SUV value. | regions; | |
| | Time to peak activity can | Continuous | |
| | vary considerably between | measure of | |
| | regions; e.g. liver tumor | unreliability. | |
| | could have time to peak of | | |
| | 4-5 hours whilst | | |
| | elsewhere, time to peak of | | |
| | 60 minutes may be | | |
| | sufficient. If time of scan | | |
| | after injection is short, and | | |
| | anatomical location of | | |
| | tumor has high time to | | |
| | peak, value may be | | |
| | unreliable within the study, | | |
| | and hence, between | | |
| | studies. | | |
| Patient Size | Large variation between | Continuous | Medium-High |
| (height/weight) | studies can have | scale | |
| | significant effect on SUV | | |
| | calculation. Large weight | | |
| | loss can be attributed to | | |
| | chemotherapy. | | |
| Tumor heterogeneity | Large tumors with necrotic | Range scale | Medium-High |
| | centers may | | |
| | underestimate uptake | | |
| | considerable. | | |

TABLE 5
Inferred Patient Factors

| | | Value | |
|---|---|---|---|
| Factor | Notes | Range | Significance |
| Confidence in LC | An assessment of whether | Range scale | Requires literature |
| | the LC population norm is | | search on LV factors. |
| | likely to hold in this study. | | |
| | The LC assumption is | | |
| | unlikely to hold in some | | |
| | anatomical regions, when | | |
| | comparing healthy and | | |
| | diseased data from the | | |
| | same patient. | | |
| Liver SUV sensibility | SUVs in the liver are | Range scale | ? |
| check | reported to be stable | | |
| | between studies in healthy | | |
| | patients. Wide variation in | | |
| | liver SUV may be an | | |
| | indicator that the SUV | | |
| | cannot be reliably | | |
| | calculated elsewhere. | | |

Factors that affect the SUV but that either cannot be measured or the significance is not known include:

Proportion of fat body content

Perfusion at site of measurement

Type of chemotherapy

Although modifications and changes may be suggested by those skilled in the art, it is the intention of the inventor to embody within the patent warranted hereon all changes and modifications as reasonably and properly come within the scope of his contribution to the art.

I claim as my invention:

1. A method of processing datasets representing medical scans comprising the steps of:
for each dataset, determining conditions associated with a number of factors affecting Standardized Uptake Value (SUV);
computing a confidence measure from the conditions, which confidence measure provides a measure of similarity of conditions affecting SUV between datasets and
visually displaying a representation of said confidence measure.

2. A method according to claim 1, wherein the confidence measure is calculated as a weighted sum of scores, wherein each score has a value dependent on whether conditions or parameter values for a factor affecting SUV is the same or different in each scan.

3. A method according to claim 1 wherein the scan is a Positron Emission Tomography scan.

4. A method according to claim 1 wherein the scan is a Single Photon Emission Computed Tomography scan.

5. An apparatus for processing datasets representing medical scans comprising:
a processor;
an input unit connected to the processor allowing entry into the processor of conditions associated with a number of factors affecting Standardized Uptake Value (SUV);
said processor being configured to compute a confidence measure from the conditions, said confidence measure initiating a measure of similarity of conditions affecting SUV between datasets; and
a display at which a representation of said confidence measure is visually displayed.

6. An apparatus according to claim 5, wherein the processor is configurable to calculate the confidence measure as a weighted sum of scores, each score having a value dependent on whether conditions or parameter values for a factor affecting SUV is the same or different in each scan.
